(19) United States
(12) Patent Application Publication
(10) Pub. No.: US 2003/0233343 A1
(43) Pub. Date: Dec. 18, 2003

(54) System and method for generating custom business reports for a WEB application

(75) Inventor: Bo Li, Shanghai (CN)

Correspondence Address: John R. Pivnichny, IBM Corporation, Dept. IQ0A/Bldg. 040-3, 1701 North Street, Endicott, NY, 13760, US

(73) Assignee: International Business Machines Corporation, Armonk, NY

(21) Appl. No.: 10/463,287

(22) Filed: Jun. 17, 2003

(30) Foreign Application Priority Data
Jun. 18, 2002 (KR) 02 1 22649.0

(51) Int. Cl. G06F 7/00

(52) U.S. Cl. 707/1

(57) ABSTRACT

Custom business reports for a WEB application are generated by parsing a configuration file, processing data logic, and organizing data. The result of the parsed configuration file is further processed by the data logic processing. The data logic processing prepares the data to generate languages suitable for a data query from a database or for locating files. The data is then organized into a form suitable for display.

### FIELD OF THE INVENTION

The present invention relates in general to the field of database applications, and in particular to a system for generating custom reports for a WEB application from data in a database.

### BACKGROUND OF THE INVENTION

By taking advantage of the development of Microsoft Windows (trademark of Microsoft Corp.) itself, report development tools do well to achieve What-You-See-Is-What-You-Get for Non-web applications that are mainly developed under the client/server architecture in the prior art. Thus, modifications to the format of the reports does not require a great deal of work. However, in a WEB-based system, it is difficult for conventional tools to work well due to the Browser/HTML page. In this kind of project, the development of reports often takes extra time and manpower efforts. The difficulty is not caused by the report itself but by the modifications to the reports (including modifications to both the content and the format). For example, IBM WebSphere Studio (trademarks of IBM Corp.) has a report generator, but what is needed in a project is not only to generate reports, but also to easily modify the reports with fewer tests. In general, the quantity and the type of the reports are first defined in SOW (Specifications Of Work), and then detailed in the design phase of the project. Unfortunately, almost every project suffers from the changes on the reports after UT (Unit Test)/FAT (Factory Acceptance Test)/SIT (System integration Test), and even after UAT (User Acceptance Test). This results in two problems: one is how to control the quality of the reporting modules after frequent changes; and the other is how to control the cost of these changes. We often need dedicated resources to handle the changes of the reports throughout a project, which would increase the cost of the project.

Although excellent change management can decrease the side-effects of the above two problems, the report generating module is still difficult for project managers and programmers because of its born mutable characteristic. In Web-related projects, thanks to MVC (Module-View-Controller) model, the format of the report can be separated from the business logic of generating the reports. This is a great help to report generating modules. However MVC model cannot solve the above two problems, because it is the business logic of generating reports that changes frequently.

Therefore, the present invention that provides a system and method for generating custom business reports for a web application is based on the idea of developing a reusable framework with the MVC model in a web environment. To develop reports in a project, architects and programmers define the business logic and workflow of reports in one or more files such as XML files, and the framework will act according to these XML definition. Thus, most changes of the reports can be handled by modifying the XML definition of the framework. The advantage of this is converting the programming work to configuration work, obviously the latter needs less time, less testing and consequently less cost, and even the supplementals can be arranged to handle the changes of the reporting requirements. Preferably this framework also supports user-defined plug-in java programs to handle some special requirements in a particular project. Although in the above mentioned case some programming work may be required, the work load is far less compared to the original because the core business logic has been covered by the framework.

### SUMMARY OF THE INVENTION

It is an object of the present invention to provide a custom business report generating system, which can properly separates the storing, processing, and displaying of data, and therefore makes easy changes on reports.

The invention thus provides a custom business report generating system, comprising means for parsing a configuration file, means for data logic processing, and means for data organization, wherein the output result of the means for parsing a configuration file is transferred to the means for data logic processing for further processing; the means for data logic processing comprises means for data preparation for generating, from the input of the means for parsing, languages suitable for data querying from a database or suitable for file locating, then inputting the generated language into the data organization means from which query results are returned; and the means for data logic processing further comprises means for data display organization for organizing the data returned from the means for data organization into a form suitable for displaying.

The invention also provides a method for generating custom business reports for a web application, comprising a step of parsing a configuration file, a step of data logic processing, and a step of organizing, wherein the result of the step of parsing a configuration file is transferred to the step of data logic processing for further processing; the step of data logic processing comprises a step of data preparation for generating, from the result of the step of parsing, languages suitable for data queries from a database or suitable for file locating, then inputting the generated language for the step of data preparation from which query results are returned; and the step of data logic processing further comprises a step of data display organization for organizing the data returned from the step of data organization into a form suitable for displaying.

### BRIEF DESCRIPTION OF THE DRAWINGS

Preferred embodiments of the invention will now be described in more detail, by way of example, with reference to the accompanying drawings in which:

FIG. 1 shows a report generating system using MVC model, which can be applied to the present invention;

FIG. 2 is a block diagram illustrating the structure of the report generating system of the present invention; and

FIG. 3 shows a flowchart of the report generating method according to the present invention.

### DETAILED DESCRIPTION OF THE PREFERRED EMBODIMENT

XML is a flexible markup language standard which is well-known to those skilled in the art. The following is a description of a preferred embodiment of the invention using the XML language as an example.

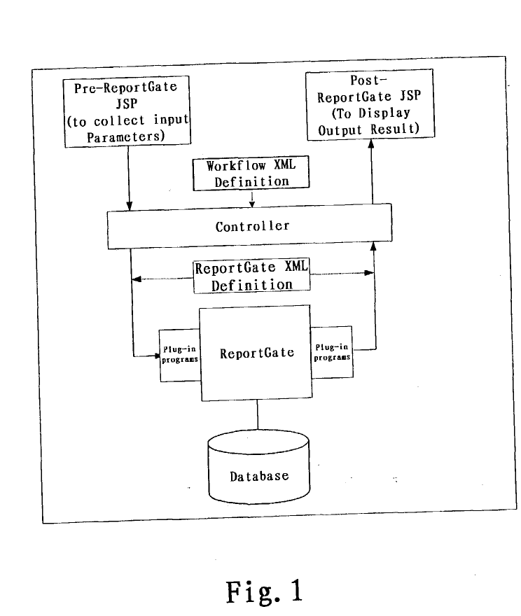

As illustrated in FIG. 1, the ReportGate framework (the core is marked with a broken line) accords with the standard MVC model, which can either use its own controllers and XML definitions to define the workflow between the models and the views, or be plugged into other MVC architectures such as the IBM JADE framework.

It is a key point of the invention that at a very low level, every report needs to retrieve data from a database because in most projects, reports are generated from data in the database. In the preferred embodiment of the present invention, the database query language, such as SQL language is used to describe this process.

Most reports are generated during the process of interacting with users. Therefore, in the preferred embodiment of the invention, a JavaServer Page (JSP) (or other suitable form) is used to collect input parameters (the parameters are defined in an XML file) from the users. The parameters are then sent to ReportGate. ReportGate gets the defined SQL from an XML configuration file, combines it with the parameters and then retrieves data from the database. The results are delivered to the results JSP which picks up the data according to an XML configuration file and displays the data in a predefined format.

As it can be seen from the flowchart of the invention, if the user wants to change the content of the reports, he or she may simply modify the XML configuration files. For example, if one wants to change the format of a report, he or she needs only to modify the result display page. With the present invention, most of work for the reports becomes a job of configuration. Since the framework of the present invention is independent from actual reports and can be systematically tested in advance, fewer tests are needed after the modifications to the configuration. Using the invention, the report modules can be developed with better control on both of the quality and the cost.

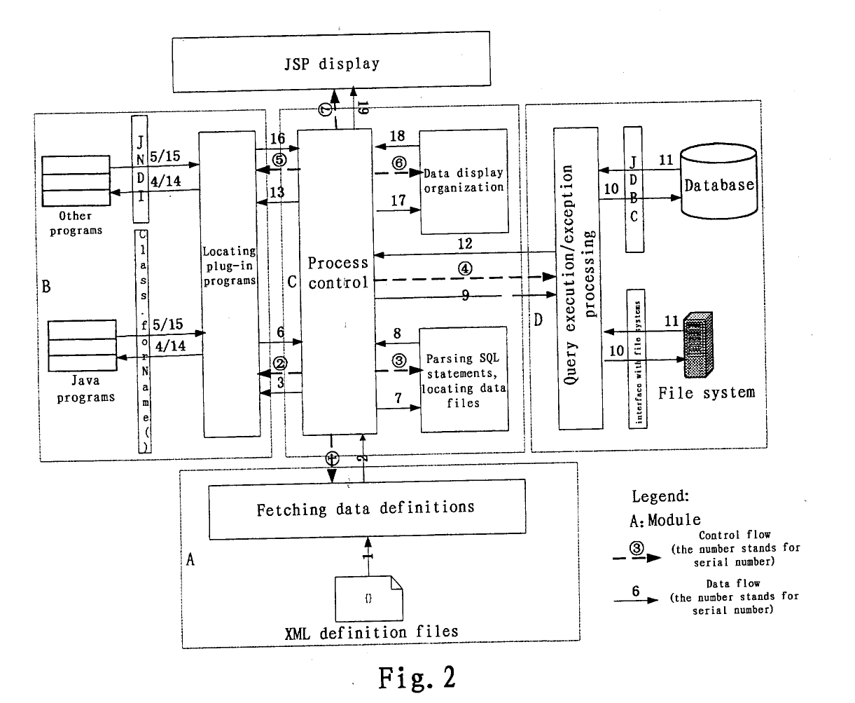

FIG. 2 is a block diagram showing the structure of ReportGate in accordance with the present invention. As illustrated in FIG. 2, the ReportGate of the present invention mainly comprises four parts: module A for parsing an XML configuration file, module B for driving plug-in programs, module C for data logic processing and module D for data organization. The following is the description on the four modules A, B, C and D shown in FIG. 2, and the control flows and data flows thereof:

### A. The Module for Parsing XML Configuration File

By introducing XML into definition files of ReportGate, the flexibility and readability of a definition file are greatly improved, such that users do not need to learn a new script language as required when using other report tools. In this module A of ReportGate, the report configuration information defined in XML format is parsed for use by other modules.

The control flow 1 in module A means that when the definition is refreshed on a regular basis or by the system, the module for data logic processing will call the current module A.

Data flow 1 is an originally defined data flow read from an XML definition file. Now we will use a simple XML definition file as an example to explain the data flow (for the purpose of simplification, the following XML file is an abstract view in a browser)

<?xml version=“1.0” encoding=“GB2312” ?>
− <ReportGateConfig>
− <preloadMethods>
+ <method identifer=“ReportFieldConverter”

classname=“com.ibm.cn.report.ReportHelper” methodname=“HttpRequestParameter”>

```
− <parameters>
  <parameter index=“1” type=“String” />
  </parameters>
  </method>
+ <method identifer=“PasswordGet”
```

classname=“com.ibm.cn.report.ReportHelper” methodname=“PasswordGet”>

```
− <parameters>
  <parameter index=“1” type=“String” />
  <parameter index=“2” type=“String” />
  </parameters>
  </method>
  </preloadMethods>
− <Database number=“1”>
  <name>jdbc:db2:ibmcncom</name>
  <user>c5i2com</user>
  <password>[$=PasswordGet(ibmcncom,c5i2com)$]</password>
  </Database>
− <Database number=“2”>
  <name>jdbc:oracle:thin:@10.10.20.10:1521:wms </name>
  <user>db2inst2</user>
  <password>[$=PasswordGet(ibmshop,db2inst2)$]</password>
  </Database>
− <Report reportName=“GeneralInOutReport”>
  <reportDesc>warehouse in and out report</reportDesc>
− <columns>
+ <column index=“1”>
  <columnName>PN</columnName>
  <columnDesc>Product Serial No.</columnDesc>
  <columnWidth>12</columnWidth>
  <data>[$=1$]</data>
  </column>
  </columns>
− <datasource database=“1”>
  <SQLStatement>SELECT . . . </SQLStatement>
+ <SQLParams>
− <param index=“1”>
  <SQLParamName>LocationID</SQLParamName>
  <SQLParamFrom>[$=HttpRequestParameter([$=SQLParamName$])$]</SQL
```

ParamFrom>

```
  <SQLParamType>Set</SQLParamType>
  </param>
− <param index=“2”>
  <SQLParamName>City</SQLParamName>
  <SQLParamFrom>[$=HttpRequestParameter([$=SQLParamName$])$]</SQL
```

ParamFrom>

```
  <SQLParamType>Set</SQLParamType>
  </param>
− <param index=“3”>
  <SQLParamName>ResellerCode</SQLParamName>
  <SQLParamFrom>[$=HttpRequestParameter([$=SQLParamName$])$]</SQL
```

ParamFrom>

```
  <SQLParamType>Set</SQLParamType>
  </param>
− <param index=“4”>
  <SQLParamName>Date</SQLParamName>
  <SQLParamFrom>SysDate</SQLParamFrom>
  <SQLParamType>Replace</SQLParamType>
  </param>
− <param index=“5”>
  <SQLParamName>BrandID</SQLParamName>
  <SQLParamFrom>[$=HttpRequestParameter([$=SQLParamName$])$]</SQL
```

ParamFrom>

```
  <SQLParamType>Set</SQLParamType>
  </param>
− <param index=“6”>
  <SQLParamName>PN</SQLParamName>
  <SQLParamFrom>[$=HttpRequestParameter([$=SQLParamName$])$]</SQL
```

ParamFrom>

```
  <SQLParamType>Set</SQLParamType>
  </param>
− <param index=“7”>
  <SQLParamName>FromToWhom</SQLParamName>
  <SQLParamFrom>[$=HttpRequestParameter([$=SQLParamName$])$]</SQL
```

ParamFrom>

```
  <SQLParamType>Set</SQLParamType>
  </param>
  </SQLParams>
  </datasource>
  </Report>
  </ReportGateConfig>
```

It can be seen that what is defined in the definition file are: two plug-in programs (HttpRequestParameter and PasswordGet), the data source to be used by the report (there are two kinds of databases in the example), a report (the warehouse in and out report) in which the way of data organization of the report (an SQL statement with parameters) is defined, and the way of display organization of the report (the results are transferred to a display JSP by column). For the functions of the above two definitions, an explanation will be given in the corresponding data flows that follow herein.

Data flow 2 is a definition data flow which has been parsed by an XML parsing engine. The definition data flow is stored in the memory in the form of a DOM tree at this moment. It shall be appreciated for those skilled in the art that there are two standard ways to parse XML: SAX and DOM. When DOM is used to parse an XML file, it reads the file, divides the file into individual objects such as elements, attributes, notes and so on, and then creates a tree structure for the document in the memory. The advantage of using DOM is that each object can be referred to and operated on. The disadvantage is that DOM has to create a tree structure for each document, requiring a large amount of memory, particularly when the document size is very large. However, the configuration file of ReportGate has no such problem since it won't be nearly as large. Whereas in the case of SAX, which is event-driven, only corresponding parts of the XML document (as necessary), rather than the whole XML document, are read into the memory. Because the whole document is not in the memory, there are parts of the document that can't be randomly accessed, and the developer has to sequentially process information. However, in the present invention, both DOM and SAX can be used as well as other suitable ways without departing from the scope of the invention.

### B. The Module for Driving Plug-In Programs

ReportGate provides an interface for plug-in programs. Users can plug their own programs, which can be driven by ReportGate, into the whole ReportGate Framework. Users are thus allowed to accomplish some special custom functions without modifying the ReportGate. For example, users may preprocess data prior to report generation and/or post-process the format of the report after generation and so on. In the module B of the ReportGate, both the control interface and the data interface for driving plug-in programs are implemented. Both interfaces enable the data to be processed by the external programs under the control of the framework.

In ReportGate, two methods are used to plug-in the programs: For plug-in programs in JAVA, a JAVA virtual machine (JVM) will call them directly by a java method in the form of Class.forName( ). For the plug-in programs coded in other languages, JNI (Java Native Interface), which is well-known to those skilled in the art, is used to call them. Of course, ReportGate can also run executable programs directly through a call by the operating system.

There are two control flows into module B. The two control flows, that are the control flow for preprocessing (control flow 2) and the control flow for post-processing (control flow 5), represent two moments at which plug-in programs are called respectively. Now, we will explain the corresponding data flow with the preprocessing definition in the above example.

<method identifer=“PasswordGet” classname=“com.ibm.cn.report. ReportHelper” methodname=“PasswordGet”>

```
− <parameters>
  <parameter index=“1” type=“String” />
  <parameter index=“2” type=“String” />
  </parameters>
  </method>
− <Database number=“1”>
  <name>jdbc:db2:ibmcncom</name>
  <user>c5i2com</user>
  <password>[$=PasswordGet(ibmcncom,c5i2com)$]</password>
</Database>
```

The object of the plug-in program PasswordGet in this example is to avoid the password of the data resource (database) of the report to be written in the definition file in the form of plaintext. The password is obtained dynamically by calling the program during the execution thereof. This is only one example for preprocessing, as there are various other plug-in programs that can carry out different functions. Therefore, data flow 3, which flows into the present module B, comprises the locating information (indicating which program package it locates) and the parameters of the plug-in programs. After locating, the present module B transfers the parameter information (two string variables) and the current parameter value (user c5i2com in the ibmcncom database) to the running program through class.forName( ) by putting them into data flow 4, then gets the running results of the program from data flow 5, and returns the results to the control module by putting them into data flow 6. The control module submits the results to the corresponding requester.

The data flow for post-processing (13/14/15/16) is consistent with the data flow for preprocessing in terms of the type and the manner of flowing. It should be mentioned that the data flow for post-processing increases the flexibility of the reports greatly. Taking the employee personnel report as an example, after the control module gets all staff data from a database, it transfers the data to a post-processing program for filtering. We can associate the authority of the present user with the data displayed for him/her (for example, regular employees are prevented from seeing salary of others etc), and thus display different information for different users. The flexible post-process can also accomplish many other functions (for example, translating data dictionary: in the data source, the number “1” can stand for “approved” and “0” for “refused”. We can establish the corresponding relationship during post-processing for simplifying the front-end JSP logic).

### C. The Module for Data Logic Processing

The core processing module of ReportGate is where data is processed and formatted according to the definition in XML configuration files. According to the interface of Model-View-Controller Framework, the data is further organized into the form of a report that can be displayed in front-end JSP pages. By separating this module from the next (module for data organization), the storing, processing and displaying of the data are further separated in the Model-View-Controller framework, leading to improved flexibility of the system.

This module is an initiator of all control flows. Taking the above XML report as an example, we will explain the data flow of this module (for the purpose of simplification, we only list part of the definition.):

| − <Report reportName=“GeneralInOutReport”> | |
|---|---|
| <reportDesc>General Report on Input and Output reportDesc> | |
| − <columns> | |
| − | <column index=“1”> |

<columnName>PN</columnName>
<columnDesc>Product Serial Number>/columnDesc>
<columnWidth>12</columnWidth>
<data>[$=6$]</data>

```
  </column>
</columns>
− <datasource database=“1”>
  <SQLStatement>SELECT
```

saleinout.inouttag, psglocationLAC.name, psglocationCTY.name, psgreseller.companyName, psgbrand.brandname, saleinout.pn, saleinout.sn, psgreseller.category, psgreseller.category, saleinout.fromtowhom, saleinout.date, saleinout.price from saleinout, psglocation psglocationLAC, psglocation psgiocationCTY, psgbrand, psgreseller, psgpn where (saleinout.ResellerCode in (select psgreseller.ResellerCode from psgreseller where (psgreseller.locationid in ?) and (psgreseller.city in ?))) and (saleinout.ResellerCode in ?) and (saleinout.Date<?) and (saleinout.PN in (select PN from psgPN where BrandID in ?)) and (saleinout.PN in ?) and (saleinout.FromToWhom in ?) and (psglocationLAC.locationid=psgreseller.locationid) and (psgreseller.resellercode=saleinout.resellercode) and (psglocationCTY.locationid=psgreseller.city) and (psgbrand.brandid=psgpn.brandid) and (psgpn.pn=saleinout.pn)</SQLStatement>

```
− <SQLParams>
− <param index=“1”>
  <SQLParamName>LocationID</SQLParamName>
  <SQLParamFrom>[$=HttpRequestParameter([$=SQLParamName$])$]</S
```

QLParamFrom>

```
  <SQLParamType>Set</SQLParamType>
</param>
− <param index=“4”>
  <SQLParamName>Date</SQLParamName>
  <SQLParamFrom>SysDate</SQLParamFrom>
  <SQLParamType>Replace</SQLParamType>
```

</param>
</SQLParams>
</datasource>

After the module gets the data source definitions of a report from data flow 2, control flow 3 transfers the definition to the data preparation part (for parsing SQL statements or locating files) through data flow 7. In this example, the data source definition is a class SQL statement, and the execution parameters of the class SQL statement are also obtained from a plug-in program HttpRequestParameter (this example means that the system generates corresponding reports according to query conditions submitted by front-end users from a web page). The data preparation part integrates this data into the data which can be understood by the module for data organization (SQL statement in this example).

The data is submitted to the module for data organization from control flow 4 through data flow 9. After data flow 12 gets the result data set of the report, control flow 6 will transfer the data set to the module for data display organization through data flow 17 (control flow 5 and corresponding data flows are used for post-processing, as described in the above). The module for data display organization organizes data in the form of a hash table according to corresponding definitions in the XML definition file (see the following example):

− <columns>

| | |
|---|---|
| − | <column index=“1”> |

<columnName>PN</columnName>
<columnDesc>Product Serial Number>/columnDesc>
<columnWidth>12</columnWidth>
<data>[$=6$][$=7$]</data>

</column>

</columns>

Here we define several ‘columns’. The example gives the definition of a column named ‘Product Serial Number’, comprising its name, Product Serial Number maximal length and the way of organizing the column from the data provided by the module for data organization is a simple example that refers to combing data taken from the sixth row and the seventh row in data flow 17). When displaying the ‘Product Serial Number’, the front-end JSP report can display not only the column of data totally in the form of a column, but also can set them flexibly into the header of a cross table or a nested table according to its own logic. In another words, a data “column” generated in the module for data display organization is the direct data source to be displayed in the front-end JSP report.

It can be seen that the definition of this kind of “column” is different from the meaning of the column in a database or a data file, and it is also different from the definition of the column that is finally displayed in a JSP report (of course, the three kinds of columns may be the same in a simple report.). Introducing such a technique for organizing the display of data is to separate the high level logic from the low level storage, because in many projects, the JSP page layout designers and programmers often have difficulty understanding low level data logic (such as why a product serial number is split based on a rule before storing) and when developing reports, and they hope to acquire data with visible or straight forward meanings. By defining ‘columns’ in the system framework, ReportGate establishes a relationship, which can be adjusted by users, between the visible meaning of data and the method of data storage. In addition, the definition of these columns can be implemented by the chief system designer (such as an architect) in the project design phase and can be modified dynamically. Therefore, the workload for programmers and the requirement for their technical ability would be reduced.

In a word, by this module C, we can separate the way of data storage (for example, the data is stored in the database or in the file system, or in which table of a database?) and the high level logic (for example, the data is queried by interacting with users or, generated by system at specific time? What data and statistic parameters are needed for the monthly sales report? Is the report a cross report or a nested report?), so that flexibility of the report system is improved.

### D. The Module for Data Organization

This is the interactive part between ReportGate and the low level data storage. According to the definition in the XML configuration file, the module gets data from databases or the file system, and then transfers them to the module for logic processing for further computing and processing. The function of module D is to mask the high level logic from the location of data storage, so as to reduce the limitation of the data structure and the data access method to reports generating.

The data sources of the reports may take various forms, such as a database or a data file, and the storage location of the data source may be in a local machine of the report system, or on the network. Therefore, module D finds and returns the corresponding result dataset by parsing data organization information in data flow 9 (a SQL statement in above example.). In the examples in the specification, we define two databases (one is Oracle, the other is DB2) as the data source (shown below), and the data of ‘Warehouse In and Out Reports’ are stored in DB2. ReportGate connects the DB2 database through JDBC interface, executes query and gets the result dataset.

```
− <Database number=“1”>
  <name>jdbc:db2:ibmcncom</name>
  <user>c5i2com</user>
  <password>[$=PasswordGet(ibmcncom,c5i2com)$]</password>
  </Database>
− <Database number=“2”>
  <name>jdbc:oracle:thin:@10.10.20.10:1521:wms <name>
  <user>db2inst2</user>
  <password>[$=PasswordGet(ibmshop,db2inst2)$]</password>
```

</Database>

In this example, in order to make a high level module get only the corresponding data rather than concerning itself with the method of data storage, module D accomplishes the following functions: database locating, database connecting (including authentication mechanism and connection buffer pool), data query (executing SQL statements), exception processing, releasing of resources and so on. After these functions are encapsulated in the module, return from the dataflow 12 is only the data columns that are defined by the report data definition and of concern by high level modules. However, for the complex reports in reality, ReportGate even accomplishes other functions, for example: In consideration of the requirements for system performance, the data restrictions, data modification operations and file system access operations will be read to memory from the database at one time. Above all, what is accomplished in the logic of this layer are various operations related to the low level storage. The encapsulating of these functions allows the users to concentrate more on the logic report, rather than programming for data access and debugging.

According to the present invention, one of the direct ways to change the reports is to rewrite or directly modify an XML configuration file. However, according to one preferred embodiment of the invention, a simpler way of modifying an XML configuration file has been introduced by using the ‘?’ parts of the XML configuration files. For example, suppose that a user inputs the following XML configuration file:

<databaseList>

<database sequence=“1”>

<!−−the sequence in the above database list−−>
<dbName>jdbc:db2:PSG</dbName>
<dbuser>db2inst2</dbuser>
<dbpassword>db2inst2</dbpassword>

</database>

</databaseList>
<ReportList>

<Report name=“GeneralSaleInOut”>

<DataSource DBSequence=“1”>

<ReqParamList>

<!−−Parameters need to be got from the HTTP request−−>
<paramFromRequest sequence=“1”>

<ParamName>resellerCode</paramName>

</paramFromRequest>

</ReqParamList>
<SQL>Select inOutTag, resellerCode from SaleInOut where

resellerCode=?</SQL>

</DataSource>
. . . . . . . . .

In the above XML configuration file, it is first stated that the data source for the report and the columns are in a database. The “?” in the “<SQL>” portion provides an opportunity for end users to set the parameters through a front-end web page. Thus, customizing of the report becomes feasible. There may be several “?”s in an SQL statement. The sequence of and the corresponding relationship between the parameters of SQL and the parameters of HTTP request is defined in the <paramFromRequest> portion. Although “?” is used to set parameters in the embodiment of the present invention, it is obvious for those skilled in the art that other specific marks can also be used, and different specific marks can be used to mark different parameters.

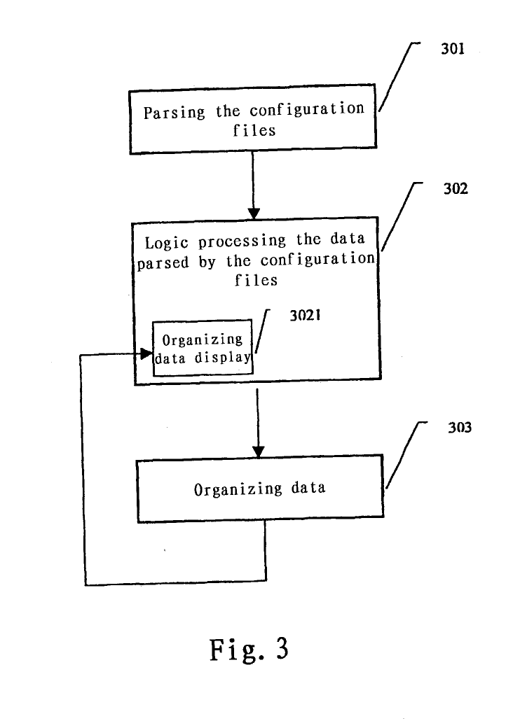

FIG. 3 shows a preferred embodiment of the report generating method of the invention. As shown in FIG. 3, the method of generating custom reports according to the invention comprises three steps, step 301 of parsing a configuration file, step 302 of data logic processing and step 303 of data organization, wherein the result of step 301 of parsing a configuration file is transferred to step 302 of data logic processing. In addition, the step of parsing a configuration file comprises parsing some specific marks in the configuration file into specific parameters. Step 303 of data logic processing comprises a step of data preparation, which uses the results of the step of parsing the configuration file as inputs to generate the languages suitable for querying a database or a file for transferring to the step of data organization, and returns the query results of the step of data organization. The step of data logic processing further comprises a step of data display organization for organizing the data returned from the step of data organization into a form suitable for displaying. The step of data display organization combines the data returned as results of the step of data organization, and makes the combined data suitable for acting as a direct data source for the front-end display of reports. In the present preferred embodiment of the invention, said parsing a configuration file is to parse an XML configuration file. However, it will be appreciated for those skilled in the art that the key point of the invention is not the type of the configuration files. In order to achieve the object of the invention, any proper configuration files, existing or available in the future, can also be used. In the preferred embodiment of the invention, the step of data logic processing further comprises a step of driving a plug-in program to call a plug-in program. The step of driving a plug-in program operates in at least one of the following three ways to call a plug-in program: 1) to call directly in the form of Class.ForName ( ) by a Java virtual machine; 2) to call by a JNI interface; and 3) to call directly by the operating system. The called plug-in program may comprise, for example, a password-getting program.

Moreover, according to the preferred embodiment of the invention, the invention is developed in the Java language, and data is encapsulated as Data Beans in the process of data flow, namely, the data to be transferred among modules of the invention are encapsulated as Data Beans.

Furthermore, according to the preferred embodiment of the invention, there are three ways to determine whether the data would be processed on the database level or on the front-end level after taking from a database:

A. It is difficult for the post-processing of some data to be implemented on the database level. For example, suppose it is required for the 0/1 status bit in a database to be explained according to user's preference for log-in language as Yes/No, and corresponding words in three languages of English, Chinese, and Japanese (sometimes even more). However, information for three languages or more usually cannot be stored in the same database at one time because of the limitation of the internal storing code of the database. The operation like this is accomplished by introducing a program of post-processing in the preferred embodiment of the invention.

B. The operations for searching and translating a huge data dictionary are generally implemented in a database. For example: A machine contains several components, the serial numbers for all of the components contained in the machine stored in the description records in a database. If a report is required to display the information of the components such as their names, places of production and so on, we have to search the corresponding component table according to the serial numbers of these components. In an example of the invention, such component tables may contain 300,000 records. It is obvious that a join operation applies to the operations like this in order to make full use of the capability of the database.

C. For a small amount of data, which can be processed by both the above methods, which method is to be used can be decided depending upon actual maintainability of the system and the difficulty of developing the system. In the example in which the employee personnel report (described above), if the operations need to be accomplished on the database level, programmers have to write different SQL query statements (for selecting different columns to display) for report readers who have different accessing privileges. Compared to the implementation of calling the existing programs in a user privilege module by the post-processing program, the latter is obviously more convenient.

Although the present invention is described with reference to the preferred embodiment, various modifications, improvements and changes can be made to the above specific embodiments within the scope taught by the present specification.

1. A system for generating custom business reports for a WEB application, comprising:
means for parsing a configuration file;
means for data logic processing; and
means for data organization,
wherein the result output from the means for parsing a configuration file is transferred to the means for data logic processing for further processing, the means for data logic processing comprises means for data preparation for generating, from the input from the means for parsing, languages suitable for data query from a database or for file locating, and the means for data logic processing further comprises means for data display organization for organizing the data from the means for data organization into a form suitable for display.

2. The system for generating custom business reports of claim 1, wherein said means for parsing a configuration file comprises means for parsing an XML configuration file.

3. The system for generating custom business reports of claim 2, further comprising means for driving plug-in programs, which is connected to the means for data logic processing such that the means for data logic processing may call a plug-in program through the means for driving plug-in programs.

4. The system for generating custom business reports of claim 3, characterized in that said means for data display organization is arranged to combine data retrieved from the means for data organization such that the combined data is suited for acting as a direct data source for the front-end display of reports.

5. The system for generating custom business reports of claim 3, characterized in that the means for driving plug-in programs operates in at least one of the following three ways to call a plug-in program: 1) to call in the form of Class.forName ( ) directly by a Java virtual machine; 2) to call by a JNI interface; and 3) to call directly by an operating system.

6. The system for generating custom business reports of claim 5, characterized in that the plug-in programs comprise at least a password-get program.

7. The system for generating custom business reports of claim 5, characterized in that the means for parsing an XML configuration file is arranged to parse certain parameters in the XML configuration file as specific parameters.

8. A method of generating custom business reports for a WEB application, comprising the steps of:
parsing a configuration file;
data logic processing; and
data organizing,
wherein a result of the step of parsing a configuration file is transferred to the step for data logic processing for further processing, the step for data logic process comprises a step for data preparation for generating, from the result of the step of parsing, languages suitable for data query from a database or for file locating, and the step for data logic process further comprises a step for data display organization for organizing the data from the step for data organization into a form suitable for display.

9. The method of generating custom business reports of claim 8, wherein said step of parsing a configuration file comprises a step of parsing an XML configuration file.

10. The method of generating custom business reports of claim 9, characterized in that said step for data logic processing comprises a step of driving a plug-in program to call a plug-in program.

11. The method of generating custom business reports of claim 10, characterized in that said step for data display organization is arranged to combine the data retrieved as a result of the step for data organization such that the combined data is suited for acting as a direct data source for the front-end display of reports.

12. The method of generating custom business reports of claim 10, characterized in that the step of driving plug-in programs operates in at least one of the following three ways to call a plug-in program: 1) to call in the form of Class.forName ( ) by a Java virtual machine; 2) to call by a JNI interface; and 3) to call directly by an operating system.

13. The method of generating custom business reports of claim 12, characterized in that the plug-in programs comprise at least a password-get program.

14. The method of generating custom business reports of claim 12, characterized in that the step of parsing XML configuration file comprises a step of parsing some certain parameters in the XML configuration file as special parameters.

15. A computer program product for generating custom business reports for a WEB application, comprising:
computer readable means for parsing a configuration file;
computer readable means for data logic processing; and
computer readable means for data organization,
wherein the result output from the computer readable means for parsing a configuration file is transferred to the computer readable means for data logic processing for further processing, the computer readable means for data logic processing comprises computer readable means for data preparation for generating, from the input from the means for parsing, languages suitable for data query from a database or for file locating, and the computer readable means for data logic processing further comprises computer readable means for data display organization for organizing the data from the computer readable means for data organization into a form suitable for display.

16. The computer program product for generating custom business reports of claim 15, wherein said computer readable means for parsing a configuration file comprises computer readable means for parsing an XML configuration file.

17. The computer program product for generating custom business reports of claim 16, further comprising computer readable means for driving plug-in programs, which is connected to the computer readable means for data logic processing such that the computer readable means for data logic processing may call a plug-in program through the computer readable means for driving plug-in programs.

18. The computer program product for generating custom business reports of claim 17, characterized in that said computer readable means for data display organization is arranged to combine data retrieved from the computer readable means for data organization such that the combined data is suited for acting as a direct data source for the front-end display of reports.

19. The computer program product for generating custom business reports of claim 17, characterized in that the computer readable means for driving plug-in programs operates in at least one of the following three ways to call a plug-in program: 1) to call in the form of Class.forName ( ) directly by a Java virtual machine; 2) to call by a JNI interface; and 3) to call directly by an operating system.

20. The computer program product for generating custom business reports of claim 19, characterized in that the plug-in programs comprise at least a password-get program.

21. The computer program product for generating custom business reports of claim 19, characterized in that the computer readable means for parsing an XML configuration file is arranged to parse certain parameters in the XML configuration file as specific parameters.
